(19) United States
(12) Patent Application Publication
(10) Pub. No.: US 2026/0159911 A1
(43) Pub. Date: Jun. 11, 2026

(54) NON-ORIENTED ELECTRICAL STEEL SHEET AND METHOD FOR MANUFACTURING SAME

(71) Applicant: POSCO CO., LTD, Gyeongsangbuk-do, Pohang-si (KR)

(72) Inventors: Jaewan Hong, Pohang-si, Gyeongsangbuk-do (KR); Hyung Don Joo, Pohang-si, Gyeongsangbuk-do (KR); Junesoo Park, Pohang-si, Gyeongsangbuk-do (KR)

(73) Assignee: POSCO CO., LTD, Gyeongsangbuk-do, Pohang-si (KR)

(21) Appl. No.: 18/722,237

(22) PCT Filed: Dec. 20, 2022
(86) PCT No.: PCT/KR2022/020902

§ 371 Date: Jul. 24, 2024

(30) Foreign Application Priority Data
Dec. 22, 2021 (KR) 10-2021-0184496

(51) Int. Cl. C21D 9/46; C21D 6/00; C21D 8/1216; C21D 8/1244; C22C 38/00; C22C 38/02; C22C 38/04; C22C 38/06; C22C 38/14; C22C 38/60; H01F 1/147

(52) U.S. Cl. CPC C21D 9/46; C21D 6/005; C21D 6/008; C21D 8/1222; C21D 8/1233; C21D 8/1261; C22C 38/001; C22C 38/002; C22C 38/004; C22C 38/008; C22C 38/02; C22C 38/04; C22C 38/06; C22C 38/14; C22C 38/60; H01F 1/14783; C22C 2202/02

(57) ABSTRACT

A non-directional electrical steel sheet according to an embodiment of the present invention comprises: by weight %, 2.5 to 4.5% of Si; 0.04 to 1.4% of Mn; 0.2 to 1.1% of Al; 0.0005 to 0.003% of Bi: 0.0005 to 0.003% of Zr; 0.0005 to 0.004% of As; and the balance of Fe and inevitable impurities, wherein an innermost portion containing 5% O is 5 μm or less in length from the surface of the steel sheet in the inward direction.

### TECHNICAL FIELD

An embodiment of the present disclosure relates to a non-oriented electrical steel sheet and a method for manufacturing the same. Specifically, an embodiment of the present disclosure relates to a non-oriented electrical steel sheet which has suppressed rust occurrence during motor manufacturing by adjusting steel components and adjusting atmosphere conditions of cold rolled sheet annealing, and a method for manufacturing the same.

### BACKGROUND ART

An electrical steel sheet is a product used as a material for transformers, motors, and electromechanics, and unlike a general carbon steel of which workability such as mechanical properties is important, it is a functional product of which the electrical properties are important.

Required electrical properties include low iron loss, high magnetic flux density, high permeability, a high spot rate, and the like.

An electrical steel sheet is divided into an oriented electrical steel sheet and a non-oriented electrical steel sheet. An oriented electrical steel sheet is an electrical steel sheet which has excellent magnetic properties in a rolling direction by forming a Goss texture ({110}<001> texture) throughout the steel sheet, using an abnormal crystal grain growth phenomenon called secondary recrystallization. A non-oriented electrical steel sheet is an electrical steel sheet having uniform magnetic properties in all directions on a rolled sheet.

Among them, the non-oriented electrical steel sheet has uniform magnetic properties in all directions, and is generally used as a material for motor cores, generator iron cores, electric motors, and small transformers. Representative magnetic properties of the non-oriented electrical steel sheet are iron loss and magnetic flux density, and the lower the iron loss of the non-oriented electrical steel sheet, the less the iron loss lost in a process of magnetizing an iron core, and the higher the magnetic flux density, the larger the magnetic field induced with the same energy, and since less current may be applied for obtaining the same magnetic flux density, copper loss may be decreased to improve energy efficiency. However, enhancement of characteristics of the non-oriented electrical steel sheet based on a common metallurgical technique has reached its limit, and the iron loss degradation degree of the non-oriented electrical steel sheet which is not annealed for stress relief after working does not satisfy energy efficiency-related regulations requiring strict iron loss and requirements of industries related to production, transfer, conversion, and use of electric energy. Accordingly, the need for technology for improving additional magnetic properties is increasing.

Meanwhile, in motor manufacturing, the non-oriented electrical steel sheet is processed in various ways. One of the most used methods is processing a non-oriented electrical steel sheet into a desired shape and size by punching or blanking alone or in combination and then laminating the steel sheets. Herein, when oxidation occurs on the surface of the non-oriented electrical steel sheet which is the raw material or oxidation occurs on a machined shear/fracture surface to cause rust occurrence, defects in the motor manufacturing process called shortage may occur therefrom.

A top grade non-oriented electrical steel sheet having low iron loss and high magnetic flux density has a high Si content in terms of its component contents, and has high probability of rust occurrence resulting from a base material. Recently, since energy efficiency regulations have been strengthened, development of a non-oriented electrical steel sheet having suppressed rust occurrence during motor manufacturing having higher efficiency is needed.

### DISCLOSURE

### Technical Problem

The present disclosure attempts to provide a non-oriented electrical steel sheet and a method for manufacturing the same. The present disclosure attempts to provide a non-oriented electrical steel sheet which has suppressed rust occurrence during motor manufacturing by adjusting steel components and adjusting atmosphere conditions of cold rolled sheet annealing, and a method for manufacturing the same.

### Technical Solution

An exemplary embodiment of the present disclosure provides a non-oriented electrical steel sheet including, by weight: 2.5 to 4.5% of Si, 0.04 to 1.4% of Mn, 0.2 to 1.1% of Al, 0.0005 to 0.003% of Bi, 0.0005 to 0.003% of Zr, and 0.0005 to 0.004% of As, with a balance of Fe and inevitable impurities, wherein a length from a surface to an innermost portion containing 5% of O in an inward direction of the steel sheet is 0.5 μm or less.

The non-oriented electrical steel sheet according to an exemplary embodiment of the present disclosure may further include one or more of 0.001 to 0.08 wt % of Sn, 0.001 to 0.08 wt % of Sb, and 0.001 to 0.03 wt % of P.

The non-oriented electrical steel sheet according to an exemplary embodiment of the present disclosure may further include one or more of 0.010 to 0.150 wt % of Cr, 0.01 to 0.20 wt % of Cu, 0.004 wt % or less of S, 0.004 wt % or less of C, 0.004 wt % or less of N, and 0.004 wt % or less of N.

The non-oriented electrical steel sheet according to an exemplary embodiment of the present disclosure may not have rust occurrence when exposed to environments of a humidity of 50% or more and a temperature of 15° C. or higher within 48 hours.

The non-oriented electrical steel sheet according to an exemplary embodiment of the present disclosure may have iron loss W15/50 (W/kg) which is equivalent to or less than a value calculated by the following Equation 1:

$$2.9 - 2 \times ( 0.5 - t ) - 0.58 \times ( [ Si ] - 2.5 ) - 0.45 \times ( [ Al ] - 0.2 ) \qquad [ Equation 1 ]$$

wherein t is a thickness (mm) of the electrical steel sheet, and [Si] and [Al] are contents (wt %) of Si and Al in the steel sheet, respectively.

The non-oriented electrical steel sheet according to an exemplary embodiment of the present disclosure may have a magnetostriction deterioration degree (λ_{0-p,p}−λ_{0-p,e})/λ_{0-p,e} value of 0.25 or less,
wherein λ_{0-p,e} is magnetostriction due to discharge machining, and λ_{0-p,p} is magnetostriction due to punching working.

Another exemplary embodiment of the present disclosure provides a method for manufacturing a non-oriented electrical steel sheet including: hot rolling a slab including, by weight: 2.5 to 4.5% of Si, 0.04 to 1.4% of Mn, 0.2 to 1.1% of Al, 0.0005 to 0.003% of Bi, 0.0005 to 0.003% of Zr, and 0.0005 to 0.004% of As, with a balance of Fe and inevitable impurities, thereby providing a hot rolled sheet; pickling the hot rolled sheet 2 to 4 times; cold rolling the pickled hot rolled sheet to manufacture a cold rolled sheet; and annealing the cold rolled sheet.

The annealing of the cold rolled sheet may be performed at a temperature of an annealing temperature of 600° C. or higher under an atmosphere having an oxygen partial pressure of 10 mmHg or less and a dew point of 10° C. or lower.

After the manufacturing of a hot rolled sheet, first annealing of the hot rolled sheet and second annealing of the hot rolled sheet may be further included.

The first annealing of the hot rolled sheet is maintaining at 980 to 1150° C. for 60 to 150 seconds, and the second annealing of the hot rolled sheet is maintaining at 900 to 950° C. for 60 to 90 seconds.

In the annealing of the cold rolled sheet, a crack temperature may be 800 to 1070° C.

### Advantageous Effects

The non-oriented electrical steel sheet accord to an exemplary embodiment of the present disclosure has suppressed rust occurrence during motor manufacturing, has excellent magnetism, and may eventually improve efficiency of a motor in which the non-oriented electrical steel sheet is used.

The non-oriented electrical steel sheet accord to an exemplary embodiment of the present disclosure may provide a non-oriented electrical steel sheet which has a small effect of residual stress remaining after punching and shear working on magnetostriction.

In addition, according to an exemplary embodiment of the present disclosure, a non-oriented electrical steel sheet having excellent iron loss may be provided.

### MODE FOR INVENTION

The terms such as first, second, and third are used for describing various parts, components, areas, layers, and/or sections, but are not limited thereto. These terms are used only for distinguishing one part, component, area, layer, or section from other parts, components, areas, layers, or sections. Therefore, a first part, component, area, layer, or section described below may be mentioned as a second part, component, area, layer, or section without departing from the scope of the present disclosure.

The terminology used herein is only for mentioning a certain example, and is not intended to limit the present disclosure. Singular forms used herein also include plural forms unless otherwise stated clearly to the contrary. The meaning of “comprising” used in the specification is embodying certain characteristics, areas, integers, steps, operations, elements, and/or components, but is not excluding the presence or addition of other characteristics, areas, integers, steps, operations, elements, and/or components.

In the present specification, when it is mentioned that a part is “on” or “above” the other part, it means that the part is directly on or above the other part or another part may be interposed therebetween. In contrast, when it is mentioned that a part is “directly on” the other part, it means that nothing is interposed therebetween.

Though not defined otherwise, all terms including technical terms and scientific terms used herein have the same meaning as commonly understood by a person with ordinary skill in the art to which the present disclosure pertains. Terms defined in commonly used dictionaries are further interpreted as having a meaning consistent with the related technical literatures and the currently disclosed description, and unless otherwise defined, they are not interpreted as having an ideal or very formal meaning.

In addition, unless otherwise particularly described, % refers to wt %, and 1 ppm refers to 0.0001 wt %.

In an exemplary embodiment of the present disclosure, the meaning of further inclusion of an additional element is replacing iron (Fe) as a remainder by the addition amount.

Hereinafter, an exemplary embodiment of the present disclosure will be described in detail so that a person with ordinary skill in the art to which the present disclosure pertains may easily carry out the present disclosure. As those skilled in the art would realize, the described embodiments may be modified in various different ways, all without departing from the spirit or scope of the present disclosure.

A non-oriented electrical steel sheet according to an exemplary embodiment of the present disclosure includes, by weight: 2.5 to 4.5% of Si, 0.04 to 1.4% of Mn, 0.2 to 1.1% of Al, 0.0005 to 0.003% of Bi, 0.0005 to 0.003% of Zr, and 0.0005 to 0.004% of As, with a balance of Fe and inevitable impurities.

First, the reason for limiting the components of the non-oriented electrical steel sheet will be described.

### Si: 2.5 to 4.5 wt %

Silicon (Si) is a main element added for lowering an eddy current loss of iron loss by increasing resistivity of a steel. When Si is added too little, iron loss is deteriorated. Therefore, it is favorable to increase a Si content in terms of iron loss, but when Si is added too much, brittleness of a material is increased to cause sheet breaking during winding and cold rolling, resulting in sharp decline of rolling productivity. Therefore, Si may be included in the range described above. More specifically, Si may be included at 2.5 to 3.7 wt %.

### Mn: 0.04 to 1.40 wt %

Manganese (Mn) serves to increase resistivity of a material to improve iron loss and form a sulfide. When Mn is added too little, a sulfide is finely precipitated to deteriorate magnetism. On the contrary, when Mn is added too much, formation of an unfavorable {111} texture may be promoted to decrease magnetic flux density. Therefore, Mn may be included in the range described above. More specifically, Mn may be included at 0.30 to 1.00 wt %.

### Al: 0.2 to 1.1 wt %

Aluminum (Al) plays an important role in decreasing iron loss by increasing resistivity with Si, and also improves rollability or improves workability during cold rolling. When Al is added too little, it has no effect on reduction of iron loss, and a precipitation temperature of AlN is lowered to finely form a nitride to deteriorate magnetism. On the contrary, when Al is added too much, a nitride is excessively formed to deteriorate magnetism, and problems are caused in all processes such as steel making and continuous casting to greatly deteriorate productivity. Therefore, Al may be included in the range described above. More specifically, Al may be included at 0.5 to 0.8 wt %.

### Bi: 0.0005 to 0.0030 wt %

Bismuth (Bi) is segregated in a crystal grain boundary as a segregation element, thereby suppressing reduction of crystal grain boundary strength and fixation of dislocation in the crystal grain boundary. Thus, it has an effect of suppressing an increase in working stress during shear and punching working and reducing a working stress depth at which magnetism is deteriorated by working stress, but when it is added too much, crystal grain growth may be suppressed to deteriorate magnetism. Therefore, Bi may be added in the range described above. More specifically, Bi may be included at 0.0010 to 0.0025 wt %.

### Zr: 0.0005 to 0.0030 wt % and As: 0.0005 to 0.0040 wt %

Since zirconium (Zr) or arsenic (As) may contribute to precipitate formation to suppress microprecipitate formation and serve to lower density of microprecipitates which cause residual stress by working, a Zr content may be 0.0005 to 0.0030 wt %, and an As content may be 0.0005 to 0.0040 wt %. More specifically, a Zr content may be 0.0010 to 0.0025 wt %, and an As content may be 0.0010 to 0.0030 wt %.

The non-oriented electrical steel sheet according to an exemplary embodiment of the present disclosure may further include one or more of 0.001 to 0.08 wt % of Sn, 0.001 to 0.08 wt % of Sb, and 0.001 to 0.03 wt % of P.

### Sn: 0.001 to 0.080 wt %

Since tin (Sn) may be added for segregating on a crystal grain boundary and a surface to improve the texture of a material and suppress surface oxidation, it may be added for improving magnetism. When an amount of Sn added is too small, the effect may be insignificant. When Sn is added too much, crystal grain boundary segregation may become severe to deteriorate surface quality and have increased hardness to cause breaking of a cold rolled sheet to deteriorate rollability. Therefore, Sn may be added in the range described above. More specifically, Sn may be further included at 0.005 to 0.050 wt %.

### Sb: 0.001 to 0.080 wt %

Since antimony (Sb) is segregated on the crystal grain boundary and the surface and serves to improve the texture of a material and suppress surface oxidation, it may be added for improving magnetism. When an amount of Sb added is too small, the effect may be insignificant. When Sb is added too much, grain boundary segregation may become severe to deteriorate surface quality and have increased hardness to cause breaking of a cold rolled sheet to deteriorate rollability. Therefore, Sb may be added in the range described above. More specifically, Sb may be further included at 0.005 to 0.050 wt %.

### P: 0.001 to 0.030 wt %

Phosphorus (P) serves to increase resistivity of a material, and also is segregated in the grain boundary to improve texture, thereby increasing resistivity and lowering iron loss. When an amount of P added is too small, a segregation amount is too small and there may be no effect of texture improvement. When the amount of P added is too much, formation of texture which is unfavorable to magnetism is caused so that there is no effect of texture improvement and P is excessively segregated in the grain boundary to deteriorate rollability and workability, which may make production difficult. Therefore, P may be added in the range described above. More specifically, P may be further included 0.005 to 0.015 wt %.

The non-oriented electrical steel sheet according to an exemplary embodiment of the present disclosure may further include one or more of 0.010 to 0.150 wt % of Cr, 0.01 to 0.20 wt % of Cu, 0.004 wt % or less of S, 0.004 wt % or less of C, 0.004 wt % or less of N, and 0.004 wt % or less of Ti.

### Cr: 0.010 to 0.150 wt %

Chromium (Cr) is segregated on the surface when appropriately adjusting annealing conditions. Only when Cr is included in the range described above, segregation appropriately occurs. When Cr is included less than the range, there is no surface segregation effect, and when Cr is present too much, brittleness of a material is strengthened to cause a problem. More specifically, 0.010 to 0.100 wt % of Cr may be further included.

### Cu: 0.01 to 0.20 wt %

Copper (Cu) serves to form a sulfide with Mn. When Cu is further added, if it is added too small, CuMnS may be finely precipitated to deteriorate magnetism. When Cu is added too much, high temperature brittleness occurs, so that cracks may be formed during soft casting or hot rolling. More specifically, Cu may be further included at 0.01 to 0.10 wt %.

### S: 0.004 wt % or Less

Since sulfur(S) forms a fine sulfide inside a base material to suppress crystal grain growth to weaken iron loss, the lower content is preferred, and when the content is more than 0.004 wt %, it is bonded to Mn and the like to suppress crystal grain growth or greatly deteriorate magnetism after working. More specifically, S may be further included at 0.0001 to 0.0030 wt %.

### C: 0.004 wt % or Less

Since carbon (C) suppresses ferrite crystal grain growth during annealing to increase a deterioration degree of magnetism during working, and may be bonded to Ti and the like to deteriorate magnetism, it may be included at 0.004 wt % or less. More specifically, C may be included at 0.0001 to 0.0030 wt %.

### N: 0.004 wt % or Less

Since nitrogen (N) is bonded to Al, Ti, and the like to form fine and long precipitates inside a base material, is also bonded to other impurities to form a fine nitride to suppress crystal grain growth, and the like, thereby worsening iron loss, it may be further included at 0.004 wt % or less. More specifically, N may be further included at 0.0001 to 0.003 wt %.

### Ti: 0.004 wt % or Less

Since titanium (Ti) is an element which has a strong tendency to form precipitates in steel, and forms fine carbides or nitrides inside a base material to suppress crystal grain growth, the more it is added, the more the carbides and the nitrides are formed to deteriorate iron loss, and the like to deteriorate magnetism, and thus, Ti may be further included at 0.004% or less. More specifically, Ti may be further included at 0.0001 to 0.0030 wt %.

The non-oriented electrical steel sheet according to an exemplary embodiment of the present disclosure may further include one or more of 0.03 wt % or less of Mo, 0.0050 wt % or less of B, 0.0050 wt % or less of Ca, and 0.0050 wt % or less of Mg.

Since these may react with C, S, N, and the like which are inevitably included and form fine carbides, nitrides, or sulfides to adversely affect magnetism, the upper limit may be limited as described above.

The residue includes Fe and inevitable impurities. Since unavoidable impurities are impurities incorporated in a manufacturing process of a steel making step and a manufacturing process of the electrical steel sheet and are known in the art, detailed description will be omitted. Addition of elements other than the alloy component described above in an exemplary embodiment of the present disclosure is not excluded, and various elements may be included within a range which does not impair the technical idea of the present disclosure. When the additional element is further included, it replaces Fe as the remainder.

The non-oriented electrical steel sheet according to an exemplary embodiment of the present disclosure may have a length from a surface to an innermost portion containing 5% of O in an inward direction of the steel sheet of 0.5 μm or less. The surface of the steel sheet refers to an outermost surface of the steel sheet, if there is no insulation coating film, and refers to a boundary surface between a steel sheet substrate and the insulation coating film, if there is an insulation coating film on the surface of the steel sheet substrate. A method of measuring the length to the innermost portion containing 5% of O is not particularly limited, and glow discharge spectrometry (GDS) may be used. The length may vary depending on the position of steel sheet measurement, and in order to decrease measurement errors, measurement is performed at 5 or more positions and the average value may be the length. More specifically, the length from the surface to the innermost portion containing 5% of O in the inward direction of the steel sheet may be 0.05 to 0.5 μm.

When O penetrates in a large amount to the surface of the steel sheet, additional oxygen penetrates through O and rust may occur during motor manufacturing. However, in an exemplary embodiment of the present disclosure, rust does not occur during motor manufacturing. That is, rust does not occur when exposed to environments of a humidity of 50% or more and a temperature of 15° C. or higher within 48 hours. Rust has a main component of a Fe-based oxide, is distinguished from a common steel sheet with a silvery gray tint by its red color, and may be determined by confirming that there is rust having a size of 1000 μm or more after exposing a steel sheet having an area of 305 mm×30 mm or more to the environments described above.

The non-oriented electrical steel sheet according to an exemplary embodiment of the present disclosure may have iron loss W15/50 (W/kg) which is equivalent to or less than a value calculated by the following Equation 1:

$$2.9 - 2 \times ( 0.5 - t ) - 0.58 \times ( [ Si ] - 2.5 ) - 0.45 \times ( [ Al ] - 0.2 ) \qquad [ Equation 1 ]$$

wherein t is a thickness (mm) of the electrical steel sheet, and [Si] and [Al] are contents (wt %) of Si and Al in the steel sheet, respectively.

Iron loss is generally known to be smaller as the thickness of the steel sheet is smaller and the contents of Si and Al are higher. In an exemplary embodiment of the present disclosure, even when the thickness, the Si content, and the Al content of the steel sheet are reflected, iron loss is further lowered as compared with the reflected value. This may be obtained by annealing the cold rolled sheet at a low oxygen partial pressure and at a low dew point, with adjustment of a steel composition. The iron loss (W15/50) may be iron loss when a magnetic flux density of 1.5 T is induced with a frequency of 50 Hz. More specifically, it may be an average value measured in a rolling direction and a rolling vertical direction.

The non-oriented electrical steel sheet may have a magnetostriction deterioration degree (λ_{0-p,p}−λ_{0-p,e})/λ_{0-p,e} value of 0.25 or less,
wherein λ_{0-p,e} is magnetostriction due to discharge machining, and λ_{0-p,p} is magnetostriction due to punching working.

Specifically, the magnetostriction deterioration degree value may be 0.01 to 0.23, more specifically 0.05 to 0.17.

The λ_{0-p,p} value may be 7.0×10⁻⁶ or less. Specifically, it may be 3.0×10⁻⁶ to 6.65×10⁻⁶, more specifically 3.26×10⁻⁶ to 5.37×10−6.

A method for manufacturing a non-oriented electrical steel sheet according to an exemplary embodiment of the present disclosure include: hot rolling a slab including, by weight: 2.5 to 4.5% of Si, 0.04 to 1.4% of Mn, 0.2 to 1.1% of Al, 0.0005 to 0.003% of Bi, 0.0005 to 0.003% of Zr, and 0.0005 to 0.004% of As, with a balance of Fe and inevitable impurities, thereby providing a hot rolled sheet; cold rolling the hot rolled sheet to manufacture a cold rolled sheet; and annealing the cold rolled sheet.

First, a slab is hot rolled to manufacture a hot rolled sheet. Since the reason for limiting the addition ratio of each composition in the slab is the same as the reason for limiting the composition of the non-oriented electrical steel sheet described above, redundant description will be omitted. Since the composition of the slab is not substantially changed in the manufacturing process such as hot rolling, cold rolling, and cold rolled sheet annealing described later, the composition of the slab and the composition of the non-oriented electrical steel sheet are substantially the same.

Before the manufacturing of a hot rolled sheet, slab heating of heating the slab in a temperature range of 1100 to 1250° C. for 0.1 to 3 hours may be further included. When a slab heating temperature is too high, precipitates such as AlN and MnS present in the slab are solid-solubilized again and then finely precipitated during hot rolling and annealing, thereby suppressing crystal grain growth and deteriorating magnetism. Specifically, heating in a temperature range of 1150 to 1200° C. for 0.5 to 3 hours may be further included.

In the manufacturing of a hot rolled sheet, the hot rolled sheet may have a thickness of 1.6 to 3.0 mm. Specifically, the hot rolled sheet may have a thickness of 1.8 mm to 2.5 mm.

After the manufacturing of a hot rolled sheet in an exemplary embodiment of the present disclosure, first annealing of the hot rolled sheet and second annealing of the hot rolled sheet in which the hot rolled sheet is annealed may be further included.

It may be continuous annealing including the first annealing of the hot rolled sheet annealing and the second annealing of the hot rolled sheet. The first annealing of the hot rolled sheet may be performed at 980 to 1150° C. for 60 to 150 seconds. Specifically, the first annealing of the hot rolled sheet may be performed at 1030 to 1100° C. for 60 to 100 seconds.

The second annealing of the hot rolled sheet annealing may be performed at 900 to 950° C. for 60 to 90 seconds.

Next, the hot rolled sheet is cold rolled to manufacture a cold rolled sheet. Though it is applied differently depending on the thickness of the hot rolled sheet, cold rolling may be performed with a reduction rate of 70 to 95% applied so that a final thickness is 0.2 to 0.7 mm. In order to match the reduction rate, cold rolling may be performed once, or twice or more with intermediate annealing interposed therebetween. The cold rolling may be performed through 3 to 7 passes.

After the manufacturing of a cold rolled sheet, the cold rolled sheet is annealed. The annealing of the cold rolled sheet may be performed at an annealing temperature of 600° C. or higher under an atmosphere of an oxygen partial pressure of 10 mmHg or lower and a dew point of 10° C. or lower. Thus, O penetration into a finally manufactured electrical steel sheet may be suppressed, and this serves to suppress rust occurrence during motor manufacturing. Since oxygen penetration begins in earnest at the annealing temperature of 600° C. or higher, the oxygen partial pressure and the dew point temperature at a temperature of 600° C. or higher are defined. More specifically, the oxygen partial pressure may be 1 to 9 mmHg, and the dew point may be −50 to 5° C.

The annealing of the cold rolled sheet may cause cracks at 800 to 1070° C., and a crack time may be 10 seconds to 5 minutes. More specifically, the temperature may be 900 to 1050° C.

Thereafter, forming an insulation layer may be further included. Since the method for forming an insulation layer is well known in the non-oriented electrical steel sheet technology field, detailed description thereof will be omitted.

Hereinafter, preferred examples and comparative examples of the present disclosure will be described. However, the following examples are a preferred exemplary embodiment, and the present disclosure is not limited by the following examples.

### Examples

Slabs having the compositions shown in the following Table 1 were heated to about 1120° C. They were hot rolled to the thicknesses summarized in the following Table 2. Hot rolled steel sheets cooled in the air were first annealed at a temperature summarized in the following Table 2 for 90 seconds, and annealed in two stages at 930° C. for 80 seconds. Materials after the hot rolled sheet annealing were pickled, and cold rolled to the thicknesses summarized in the following Table 2. Thereafter, the cold rolled sheets were annealed at the crack temperatures summarized in the following Table 2.

Iron loss was measured by an Epstein test. At this time, the Epstein specimens had a size of 305 mm×30 mm, respectively.

The length from a surface to an innermost portion containing 5% of O in an inward direction of the steel sheet was measured by measuring 5 points of the specimen by GDS to measure the innermost position having an oxygen content of 5%.

The specimens after being allowed to stand in a constant temperature and humidity device having a humidity of 50% or more at a temperature of 15° C. or higher for 48 hours or more were observed by the naked eye and it was determined whether there was rust.

In addition, in order to measure magnetostriction, specimens for measuring magnetostriction were processed by shearing and discharge machining to measure magnetostriction at 50 Hz, 1.5 T. At this time, the magnetostriction was an average of values in a rolling direction (RD direction) and a rolling vertical direction (TD direction), and a magnetostriction value was measured by an instrument which may apply a magnetic field of 50 Hz, 1.5 T and was defined as (length change rate/length of original specimen). The magnetostriction value of the specimen processed by discharge machining was referred to as λ_{0-p,e} and the magnetostriction value by shearing and punching working was referred to as λ_{0-p,p}, and a deterioration degree value of magnetostriction was defined as (λ_{0-p,p}−λ_{0-p,e})/λ_{0-p,e}.

In the shear and punching working, clearance was set to 5% and the specimen was collected by the shearing and punching working. The clearance refers to a value obtained by dividing a gap between an upper mold and a lower mold of the shearing machine or a punching machine by the sheet thickness of a material to be processed.

The discharge machined Epstein specimen was manufactured by discharge machining of a specimen which was sheared into a specimen of 310 mm×35 mm into a size of 305 mm×30 mm.

TABLE 1

| Example | Si | Mn | Al | P | Sn | Sb | S | N | C | Ti | Bi | Zr | As |
|---|---|---|---|---|---|---|---|---|---|---|---|---|---|
| Comparative | 2.89 | 0.08 | 0.95 | 0.058 | 0.054 | 0.015 | 0.0024 | 0.0013 | 0.0012 | 0.0015 | 0.0007 | 0.0004 | 0.0044 |
| material 1 | | | | | | | | | | | | | |
| Comparative | 3.02 | 0.92 | 0.55 | 0.009 | 0.048 | 0.035 | 0.0015 | 0.0014 | 0.0022 | 0.0014 | 0.0018 | 0.0002 | 0.0004 |
| material 2 | | | | | | | | | | | | | |
| Comparative | 3.35 | 0.75 | 0.65 | 0.015 | 0.062 | — | 0.0014 | 0.0009 | 0.0018 | 0.0012 | 0.0005 | 0.0018 | 0.0003 |
| material 3 | | | | | | | | | | | | | |
| Comparative | 3.44 | 0.25 | 0.80 | 0.009 | 0.062 | 0.015 | 0.0007 | 0.0005 | 0.0008 | 0.0008 | 0.0003 | 0.0003 | 0.0004 |
| material 4 | | | | | | | | | | | | | |
| Comparative | 3.44 | 0.25 | 0.80 | 0.009 | 0.062 | 0.015 | 0.0007 | 0.0005 | 0.0008 | 0.0008 | 0.0035 | 0.0031 | 0.0043 |
| material 5 | | | | | | | | | | | | | |
| Inventive | 2.75 | 1.30 | 0.87 | 0.059 | — | 0.068 | 0.0012 | 0.0005 | 0.0019 | 0.0010 | 0.0028 | 0.0027 | 0.0029 |
| material 1 | | | | | | | | | | | | | |
| Inventive | 3.21 | 1.22 | 0.50 | 0.048 | 0.067 | 0.012 | 0.0013 | 0.0023 | 0.0030 | 0.0015 | 0.0005 | 0.0016 | 0.0005 |
| material 2 | | | | | | | | | | | | | |
| Inventive | 3.36 | 0.53 | 0.74 | 0.012 | 0.031 | 0.045 | 0.0020 | 0.0007 | 0.0024 | 0.0018 | 0.0013 | 0.0017 | 0.0027 |
| material 3 | | | | | | | | | | | | | |
| Inventive | 2.91 | 0.72 | 0.80 | 0.072 | 0.045 | — | 0.0018 | 0.0011 | 0.0021 | 0.0008 | 0.0016 | 0.0007 | 0.0035 |
| material 4 | | | | | | | | | | | | | |
| Inventive | 3.10 | 0.53 | 0.70 | 0.008 | — | 0.066 | 0.0019 | 0.0010 | 0.0018 | 0.0013 | 0.0024 | 0.0006 | 0.0017 |
| material 5 | | | | | | | | | | | | | |
| Inventive | 2.75 | 1.02 | 0.75 | 0.008 | 0.042 | 0.001 | 0.0020 | 0.0018 | 0.0020 | 0.0014 | 0.0013 | 0.0026 | 0.0006 |
| material 6 | | | | | | | | | | | | | |
| Inventive | 3.32 | 1.36 | 0.29 | 0.012 | 0.035 | 0.008 | 0.0015 | 0.0009 | 0.0010 | 0.0014 | 0.0029 | 0.0007 | 0.0019 |
| material 7 | | | | | | | | | | | | | |
| Inventive | 3.44 | 0.25 | 0.80 | 0.009 | 0.062 | 0.015 | 0.0007 | 0.0005 | 0.0008 | 0.0008 | 0.0011 | 0.0006 | 0.0020 |
| material 8 | | | | | | | | | | | | | |
| Inventive | 3.38 | 0.33 | 0.74 | 0.008 | — | 0.055 | 0.0013 | 0.0018 | 0.0010 | 0.0012 | 0.0008 | 0.0010 | 0.0023 |
| material 9 | | | | | | | | | | | | | |
| Inventive | 3.51 | 0.28 | 0.77 | 0.008 | 0.071 | — | 0.0008 | 0.0012 | 0.0015 | 0.0010 | 0.0012 | 0.0005 | 0.0021 |
| material 10 | | | | | | | | | | | | | |

TABLE 2

| | | | First hot | | Cold rolled sheet | | |
|---|---|---|---|---|---|---|---|
| | | | rolled | Cold | annealing condition | | |
| | | Hot | sheet | rolled | | Oxygen | |
| | | rolled | annealing | sheet | Crack | partial | Dew |
| | | thickness | temperature | thickness | temperature | pressure | point |
| Remarks | Steel type | (mm) | (° C.) | (mm) | (° C.) | (mmHg) | (° C.) |
| Comparative | Inventive | 2.5 | 1000 | 0.5 | 980 | 16 | −31 |
| Example 1 | Steel 1 | | | | | | |
| Inventive | Inventive | 2.3 | 980 | 0.5 | 1000 | 4 | −37 |
| Example 1 | Steel 1 | | | | | | |
| Inventive | Inventive | 2.3 | 1000 | 0.5 | 1000 | 4 | −48 |
| Example 2 | Steel 1 | | | | | | |
| Inventive | Inventive | 2.3 | 1000 | 0.5 | 980 | 3 | −10 |
| Example 3 | Steel 2 | | | | | | |
| Inventive | Inventive | 2.5 | 1000 | 0.5 | 980 | 6 | −5 |
| Example 4 | Steel 2 | | | | | | |
| Comparative | Inventive | 2.5 | 1000 | 0.5 | 1000 | 3 | 17 |
| Example 2 | Steel 2 | | | | | | |
| Comparative | Inventive | 2.3 | 1080 | 0.3 | 1000 | 14 | 34 |
| Example 3 | Steel 3 | | | | | | |
| Comparative | Inventive | 2.3 | 1020 | 0.35 | 1020 | 2 | 13 |
| Example 4 | Steel 3 | | | | | | |
| Inventive | Inventive | 2.3 | 1040 | 0.35 | 1020 | 7 | −27 |
| Example 5 | Steel 3 | | | | | | |
| Inventive | Inventive | 2 | 1040 | 0.35 | 1020 | 8 | −15 |
| Example 6 | Steel 4 | | | | | | |
| Inventive | Inventive | 2.3 | 1060 | 0.5 | 1020 | 4 | −17 |
| Example 7 | Steel 4 | | | | | | |
| Comparative | Inventive | 2 | 1050 | 0.27 | 1040 | 9 | 19 |
| Example 5 | Steel 4 | | | | | | |
| Comparative | Inventive | 2 | 1030 | 0.27 | 1020 | 18 | −28 |
| Example 6 | Steel 5 | | | | | | |
| Inventive | Inventive | 2.3 | 1040 | 0.35 | 1020 | 4 | −21 |
| Example 8 | Steel 5 | | | | | | |
| Inventive | Inventive | 2.3 | 1000 | 0.35 | 1060 | 8 | −32 |
| Example 9 | Steel 5 | | | | | | |
| Inventive | Inventive | 2.3 | 1080 | 0.35 | 1060 | 7 | 0 |
| Example 10 | Steel 5 | | | | | | |
| Comparative | Inventive | 1.8 | 1040 | 0.25 | 1000 | 13 | −4 |
| Example 7 | Steel 6 | | | | | | |
| Inventive | Inventive | 1.8 | 1030 | 0.25 | 1000 | 9 | −16 |
| Example 11 | Steel 6 | | | | | | |
| Comparative | Inventive | 2 | 1020 | 0.27 | 1020 | 6 | 18 |
| Example 8 | Steel 6 | | | | | | |
| Inventive | Inventive | 2 | 1050 | 0.27 | 1040 | 9 | −27 |
| Example 12 | Steel 6 | | | | | | |
| Inventive | Inventive | 2.3 | 1050 | 0.35 | 1040 | 9 | −23 |
| Example 13 | Steel 7 | | | | | | |
| Comparative | Inventive | 1.6 | 980 | 0.25 | 1030 | 11 | −15 |
| Example 9 | Steel 7 | | | | | | |
| Inventive | Inventive | 1.6 | 1020 | 0.25 | 1040 | 7 | −28 |
| Example 14 | Steel 7 | | | | | | |
| Inventive | Inventive | 2 | 1020 | 0.35 | 1040 | 6 | −19 |
| Example 15 | Steel 7 | | | | | | |
| Comparative | Inventive | 2 | 1080 | 0.35 | 1060 | 1 | 35 |
| Example 10 | Steel 8 | | | | | | |
| Inventive | Inventive | 2.3 | 1050 | 0.5 | 1060 | 2 | −36 |
| Example 16 | Steel 8 | | | | | | |
| Comparative | Inventive | 2.3 | 1030 | 0.3 | 1040 | 12 | −16 |
| Example 11 | Steel 8 | | | | | | |
| Inventive | Inventive | 2.3 | 1070 | 0.3 | 1040 | 3 | −42 |
| Example 17 | Steel 8 | | | | | | |
| Inventive | Inventive | 2.3 | 1010 | 0.35 | 1040 | 5 | −25 |
| Example 18 | Steel 9 | | | | | | |
| Inventive | Inventive | 2.3 | 1030 | 0.5 | 1060 | 6 | −17 |
| Example 19 | Steel 9 | | | | | | |
| Inventive | Inventive | 2.3 | 1030 | 0.5 | 1050 | 7 | −37 |
| Example 20 | Steel 9 | | | | | | |
| Inventive | Inventive | 1.6 | 1020 | 0.35 | 1050 | 4 | −8 |
| Example 21 | Steel 9 | | | | | | |
| Inventive | Inventive | 1.6 | 1030 | 0.35 | 1060 | 7 | −6 |
| Example 22 | Steel 10 | | | | | | |
| Comparative | Inventive | 1.8 | 1010 | 0.35 | 1020 | 12 | −17 |
| Example 12 | Steel 10 | | | | | | |
| Comparative | Inventive | 1.8 | 1040 | 0.35 | 1040 | 4 | 16 |
| Example 13 | Steel 10 | | | | | | |
| Inventive | Inventive | 2 | 1040 | 0.35 | 1030 | 6 | −37 |
| Example 23 | Steel 10 | | | | | | |
| Comparative | Comparative | 2.3 | 1010 | 0.35 | 1040 | 5 | −25 |
| Example 14 | Steel 1 | | | | | | |
| Comparative | Comparative | 2.3 | 1030 | 0.5 | 1060 | 6 | −17 |
| Example 15 | Steel 2 | | | | | | |
| Comparative | Comparative | 2.3 | 1030 | 0.5 | 1050 | 7 | −37 |
| Example 16 | Steel 3 | | | | | | |
| Comparative | Comparative | 1.6 | 1020 | 0.35 | 1050 | 4 | −8 |
| Example 17 | Steel 4 | | | | | | |
| Comparative | Comparative | 1.6 | 1030 | 0.35 | 1060 | 7 | −6 |
| Example 18 | Steel 5 | | | | | | |

TABLE 3

| | Inner depth | | | | | |
|---|---|---|---|---|---|---|
| | (μm) | | Iron loss | | | Magnetostriction |
| | containing 5% | Occurrence | (W15/50, | λ_{0-p, p} | λ_{0-p, e} | deterioration |
| Remarks | of oxygen | of rust | W/kg) | (×10⁻⁶) | (×10⁻⁶) | rate |
| Comparative | 1.2 | ◯ | 2.62 | 4.90 | 3.96 | 0.24 |
| Example 1 | | | | | | |
| Inventive | 0.32 | X | 2.45 | 4.28 | 3.66 | 0.17 |
| Example 1 | | | | | | |
| Inventive | 0.35 | X | 2.42 | 3.49 | 2.99 | 0.17 |
| Example 2 | | | | | | |
| Inventive | 0.08 | X | 2.35 | 5.20 | 4.58 | 0.14 |
| Example 3 | | | | | | |
| Inventive | 0.43 | X | 2.32 | 4.84 | 4.22 | 0.15 |
| Example 4 | | | | | | |
| Comparative | 1.3 | ◯ | 2.52 | 4.25 | 3.40 | 0.25 |
| Example 2 | | | | | | |
| Comparative | 2.5 | ◯ | 2.19 | 5.04 | 4.09 | 0.23 |
| Example 3 | | | | | | |
| Comparative | 1.1 | ◯ | 2.14 | 3.95 | 3.23 | 0.22 |
| Example 4 | | | | | | |
| Inventive | 0.27 | X | 1.85 | 3.67 | 3.03 | 0.21 |
| Example 5 | | | | | | |
| Inventive | 0.31 | X | 2.08 | 5.27 | 4.52 | 0.17 |
| Example 6 | | | | | | |
| Inventive | 0.15 | X | 2.39 | 5.17 | 4.17 | 0.24 |
| Example 7 | | | | | | |
| Comparative | 0.85 | ◯ | 1.94 | 4.21 | 3.68 | 0.14 |
| Example 5 | | | | | | |
| Comparative | 1.05 | ◯ | 1.96 | 4.52 | 3.89 | 0.16 |
| Example 6 | | | | | | |
| Inventive | 0.09 | X | 2.02 | 5.21 | 4.19 | 0.24 |
| Example 8 | | | | | | |
| Inventive | 0.27 | X | 2.01 | 5.24 | 4.62 | 0.13 |
| Example 9 | | | | | | |
| Inventive | 0.14 | X | 1.96 | 3.56 | 2.93 | 0.22 |
| Example 10 | | | | | | |
| Comparative | 0.78 | ◯ | 2.02 | 4.70 | 4.11 | 0.14 |
| Example 7 | | | | | | |
| Inventive | 0.41 | X | 1.96 | 3.57 | 2.94 | 0.21 |
| Example 11 | | | | | | |
| Comparative | 0.84 | ◯ | 2.06 | 3.52 | 2.98 | 0.18 |
| Example 8 | | | | | | |
| Inventive | 0.36 | X | 1.92 | 4.11 | 3.77 | 0.09 |
| Example 12 | | | | | | |
| Inventive | 0.3 | X | 2.04 | 4.41 | 3.80 | 0.16 |
| Example 13 | | | | | | |
| Comparative | 1.24 | ◯ | 1.89 | 3.29 | 2.66 | 0.24 |
| Example 9 | | | | | | |
| Inventive | 0.19 | X | 1.76 | 4.78 | 4.01 | 0.19 |
| Example 14 | | | | | | |
| Inventive | 0.28 | X | 1.92 | 5.37 | 4.33 | 0.24 |
| Example 15 | | | | | | |
| Comparative | 0.85 | ◯ | 2.04 | 4.81 | 3.99 | 0.21 |
| Example 10 | | | | | | |
| Inventive | 0.43 | X | 2.08 | 4.24 | 3.75 | 0.13 |
| Example 16 | | | | | | |
| Comparative | 0.83 | ◯ | 2.13 | 3.32 | 2.76 | 0.20 |
| Example 11 | | | | | | |
| Inventive | 0.09 | X | 1.78 | 5.05 | 4.16 | 0.21 |
| Example 17 | | | | | | |
| Inventive | 0.25 | X | 1.84 | 5.27 | 4.28 | 0.23 |
| Example 18 | | | | | | |
| Inventive | 0.14 | X | 2.14 | 5.35 | 4.54 | 0.18 |
| Example 19 | | | | | | |
| Inventive | 0.11 | X | 2.14 | 4.83 | 3.95 | 0.22 |
| Example 20 | | | | | | |
| Inventive | 0.32 | X | 1.82 | 3.88 | 3.33 | 0.17 |
| Example 21 | | | | | | |
| Inventive | 0.26 | X | 1.74 | 4.96 | 4.31 | 0.15 |
| Example 22 | | | | | | |
| Comparative | 0.96 | ◯ | 1.92 | 4.55 | 3.72 | 0.22 |
| Example 12 | | | | | | |
| Comparative | 1.38 | ◯ | 1.86 | 5.05 | 4.35 | 0.16 |
| Example 13 | | | | | | |
| Inventive | 0.17 | X | 1.75 | 5.23 | 4.39 | 0.19 |
| Example 23 | | | | | | |
| Comparative | 0.13 | X | 2.15 | 7.13 | 5.28 | 0.35 |
| Example 14 | | | | | | |
| Comparative | 0.26 | X | 2.54 | 8.7 | 6.17 | 0.41 |
| Example 15 | | | | | | |
| Comparative | 0.32 | X | 2.44 | 7.34 | 5.78 | 0.27 |
| Example 16 | | | | | | |
| Comparative | 0.14 | X | 2.37 | 5.57 | 4.32 | 0.29 |
| Example 17 | | | | | | |
| Comparative | 0.17 | X | 2.33 | 5.78 | 4.08 | 0.42 |
| Example 18 | | | | | | |

As shown in Tables 1 and 3, it was confirmed that the inventive examples which satisfied the alloy components and the manufacturing process conditions did not cause rust, had excellent iron loss values, and had small deterioration degrees of magnetostriction.

However, in Comparative Examples 1 to 13, it was confirmed that the oxygen partial pressure or the dew point temperature during the annealing of the cold rolled sheet was not appropriately adjusted, and rust occurred. In Comparative Examples 14 to 18 which did not appropriately include Bi, Zr, and As, it was confirmed that iron loss was relatively poor, and the effect of the residual stress on the magnetostriction after punching by punching working and shear working was large.

The present disclosure is not limited by the above exemplary embodiments and may be manufactured in various forms different from each other, and it may be understood that a person with ordinary skill in the art to which the present disclosure pertains may carry out the present disclosure in another specific form without modifying the technical idea or essential feature of the present disclosure. Therefore, it should be understood that the exemplary embodiments described above are illustrative and are not restrictive in all aspects.

1. A non-oriented electrical steel sheet comprising, by weight: 2.5 to 4.5% of Si, 0.04 to 1.4% of Mn, 0.2 to 1.1% of Al, 0.0005 to 0.003% of Bi, 0.0005 to 0.003% of Zr, and 0.0005 to 0.004% of As, with a balance of Fe and inevitable impurities,
wherein a length from a surface to an innermost portion containing 5% of O in an inward direction of the steel sheet is 0.5 μm or less.

2. The non-oriented electrical steel sheet of claim 1, further comprising:
one or more of 0.001 to 0.08 wt % of Sn, 0.001 to 0.08 wt % of Sb, and 0.001 to 0.03 wt % of P.

3. The non-oriented electrical steel sheet of claim 1, further comprising:
one or more of 0.010 to 0.150 wt % of Cr, 0.01 to 0.20 wt % of Cu, 0.004 wt % or less of S, 0.004 wt % or less of C, 0.004 wt % or less of N, and 0.004 wt % or less of Ti.

4. The non-oriented electrical steel sheet of claim 1, wherein:
the non-oriented electrical steel sheet does not cause rust when exposed to environments of a humidity of 50% or more and a temperature of 15° C. or higher within 48 hours.

5. The non-oriented electrical steel sheet of claim 1, wherein:
iron loss W15/50 (W/kg) is equivalent to or less than a value calculated by the following Equation 1:
$$2.9 - 2 \times ( 0.5 - t ) - 0.58 \times ( [ Si ] - 2.5 ) - 0.45 \times ( [ Al ] - 0.2 ) \qquad [ Equation 1 ]$$
wherein t is a thickness (mm) of the electrical steel sheet, and [Si] and [Al] are contents (wt %) of Si and Al in the steel sheet, respectively.

6. The non-oriented electrical steel sheet of claim 1, wherein:
the non-oriented electrical steel sheet has a magnetostriction deterioration degree (λ_{0-p,p}−λ_{0-p,e})/λ_{0-p,e} value of 0.25 or less,
wherein λ_{0-p,e} is magnetostriction due to discharge machining, and λ_{0-p,p} is magnetostriction due to punching working.

7. A method for manufacturing a non-oriented electrical steel sheet, the method comprising:
hot rolling a slab including, by weight: 2.5 to 4.5% of Si, 0.04 to 1.4% of Mn, 0.2 to 1.1% of Al, 0.0005 to 0.003% of Bi, 0.0005 to 0.003% of Zr, and 0.0005 to 0.004% of As, with a balance of Fe and inevitable impurities, thereby providing a hot rolled sheet;
cold rolling the hot rolled sheet to manufacture a cold rolled sheet; and
annealing the cold rolled sheet,
wherein the annealing of the cold rolled sheet is performed at an annealing temperature of 600° C. or higher under an atmosphere of an oxygen partial pressure of 10 mmHg or lower and a dew point of 10° C. or lower.

8. The method for manufacturing a non-oriented electrical steel sheet of claim 7, further comprising:
after the manufacturing of a hot rolled sheet, first annealing the hot rolled sheet and second annealing the hot rolled sheet.

9. The method for manufacturing a non-oriented electrical steel sheet of claim 8, wherein:
the first annealing of the hot rolled sheet is maintaining at 980 to 1150° C. for 60 to 150 seconds, and
the second annealing of the hot rolled sheet is maintaining at 900 to 950° C. for 60 to 90 seconds.

10. The method for manufacturing a non-oriented electrical steel sheet of claim 7, wherein:
in the annealing of the cold rolled sheet, a crack temperature is 800 to 1070° C.
